(19) United States
(12) Patent Application Publication
(10) Pub. No.: US 2025/0220529 A1
(43) Pub. Date: Jul. 3, 2025

(54) UE INITIATED LOWER LAYER TRIGGERED MOBILITY

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Allen, TX (US)

(21) Appl. No.: 19/002,193

(22) Filed: Dec. 26, 2024

Related U.S. Application Data
(60) Provisional application No. 63/617,026, filed on Jan. 2, 2024.
(60) Provisional application No. 63/705,763, filed on Oct. 10, 2024.
(60) Provisional application No. 63/727,071, filed on Dec. 2, 2024.

(51) Int. Cl. H04W 36/08; H04W 36/00

(52) U.S. Cl. CPC H04W 36/08; H04W 36/0072

(57) ABSTRACT

A user equipment (UE) includes a transceiver configured to receive, from a source cell, a physical downlink control channel (PDCCH) order for a first UE initiated lower layer triggered mobility (LTM) candidate cell, and transmit, to the first LTM candidate cell, during a random access procedure initiated by the PDCCH order, a random access preamble. The transceiver is also configured to receive, from the source cell, after completion of the random access procedure, a medium access control (MAC) control element (CE) including timing advance (TA) information of the first LTM candidate cell. The UE also includes a processor operatively coupled to the transceiver. The processor is configured to store the TA information of the first LTM candidate cell, and start a candidate timing alignment timer (TAT) for the first LTM candidate cell.

### CROSS-REFERENCE TO RELATED APPLICATION(S) AND CLAIM OF PRIORITY

This application claims priority under 35 U.S.C. § 119 (e) to U.S. Provisional Patent Application No. 63/617,026 filed on Jan. 2, 2024, U.S. Provisional Patent Application No. 63/705,763 filed on Oct. 10, 2024, and U.S. Provisional Patent Application No. 63/727,071 filed on Dec. 2, 2024. The above-identified provisional patent applications are hereby incorporated by reference in their entirety.

### TECHNICAL FIELD

This disclosure relates generally to wireless networks. More specifically, this disclosure relates to user equipment (UE) initiated lower layer triggered mobility.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for UE initiated lower layer triggered mobility.

In one embodiment, a user equipment (UE) is provided. The UE includes a transceiver configured to receive, from a source cell, a physical downlink control channel (PDCCH) order for a first UE initiated lower layer triggered mobility (LTM) candidate cell, and transmit, to the first LTM candidate cell, during a random access procedure initiated by the PDCCH order, a random access preamble. The transceiver is also configured to receive, from the source cell, after completion of the random access procedure, a medium access control (MAC) control element (CE) including timing advance (TA) information of the first LTM candidate cell. The UE also includes a processor operatively coupled to the transceiver. The processor is configured to store the TA information of the first LTM candidate cell, and start a candidate timing alignment timer (TAT) for the first LTM candidate cell.

In another embodiment, a base station (BS) is provided. The BS includes a processor, and a transceiver operatively coupled to the processor. The transceiver is configured to transmit, to a UE, a PDCCH order for a first UE initiated LTM candidate cell. The transceiver is also configured to receive TA information of the first LTM candidate cell, and transmit, to the UE, a MAC CE including the TA information of the first LTM candidate cell.

In yet another embodiment, a method of operating a UE is provided. The method includes receiving, from a source cell, a PDCCH order for a first UE initiated LTM candidate cell, and transmitting, to the first LTM candidate cell, during a random access procedure initiated by the PDCCH order, a random access preamble. The method also includes receiving, from the source cell, after completion of the random access procedure, a MAC CE including TA information of the first LTM candidate cell, storing the TA information of the first LTM candidate cell, and starting a candidate TAT for the first LTM candidate cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example signaling procedures for inter-gNB handover according to embodiments of the present disclosure;

FIG. 5 illustrates an example procedure for LTM according to embodiments of the present disclosure;

FIG. 6 illustrates an example method for UE initiated LTM according to embodiments of the present disclosure;

FIG. 7 illustrates an example method for identifying allowed LTM candidate cells according to embodiments of the present disclosure;

FIG. 8 illustrates another example method for identifying allowed LTM candidate cells according to embodiments of the present disclosure;

FIG. 9 illustrates another example method for identifying allowed LTM candidate cells according to embodiments of the present disclosure;

FIG. 10 illustrates another example method for identifying allowed LTM candidate cells 1000 according to embodiments of the present disclosure;

FIG. 11 illustrates another example method for UE initiated LTM according to embodiments of the present disclosure;

FIG. 12 illustrates another example method for UE initiated LTM according to embodiments of the present disclosure; and

FIG. 13 illustrates another example method for UE initiated LTM according to embodiments of the present disclosure.

### DETAILED DESCRIPTION

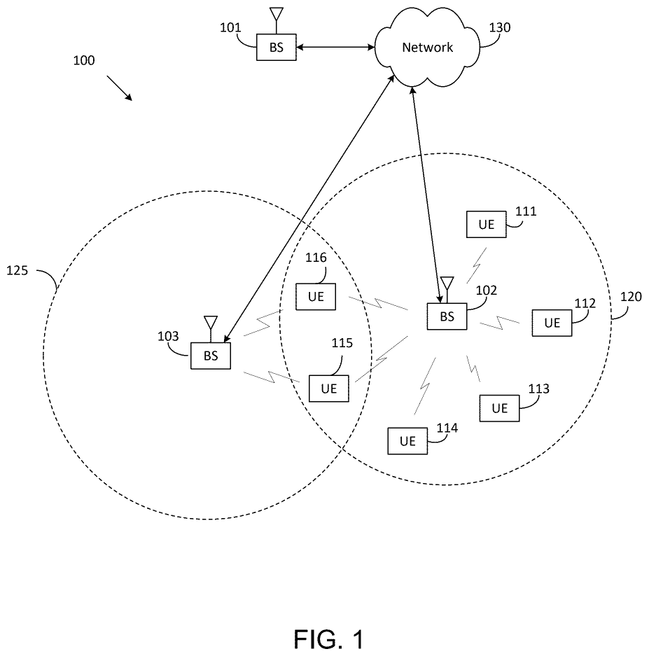

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points ((CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE initiated lower layer triggered mobility. In certain embodiments, one or more of the gNBs 101-103 includes circuitry, programing, or a combination thereof, to support UE initiated lower layer triggered mobility in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

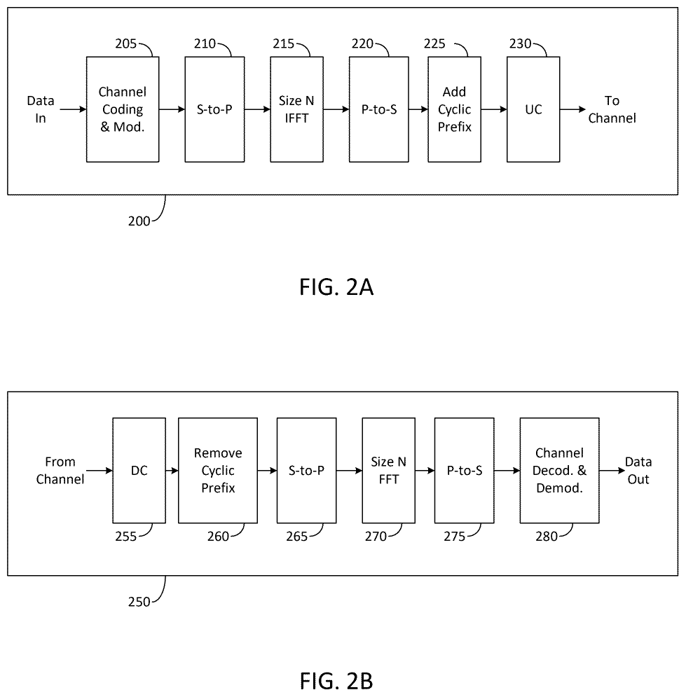

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support UE initiated lower layer triggered mobility as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

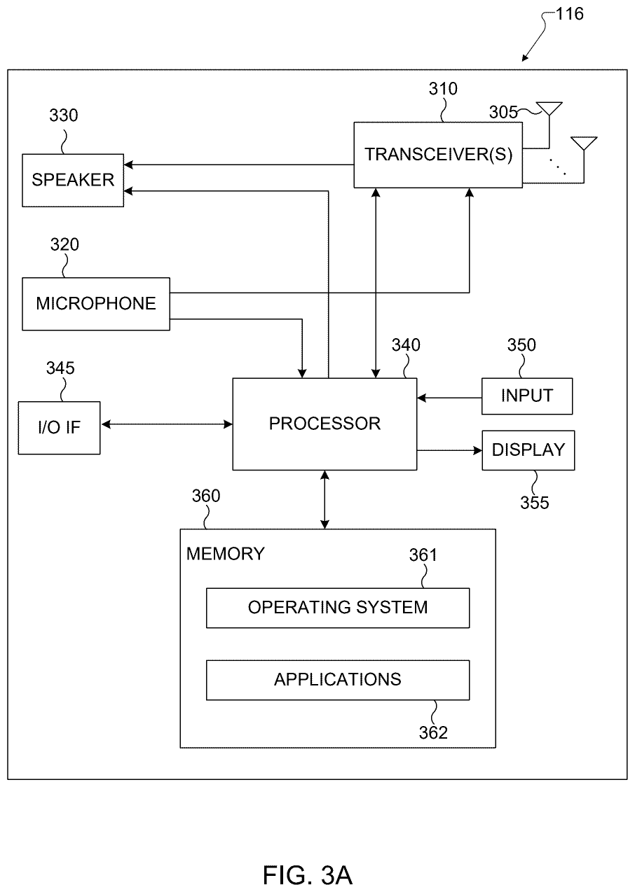

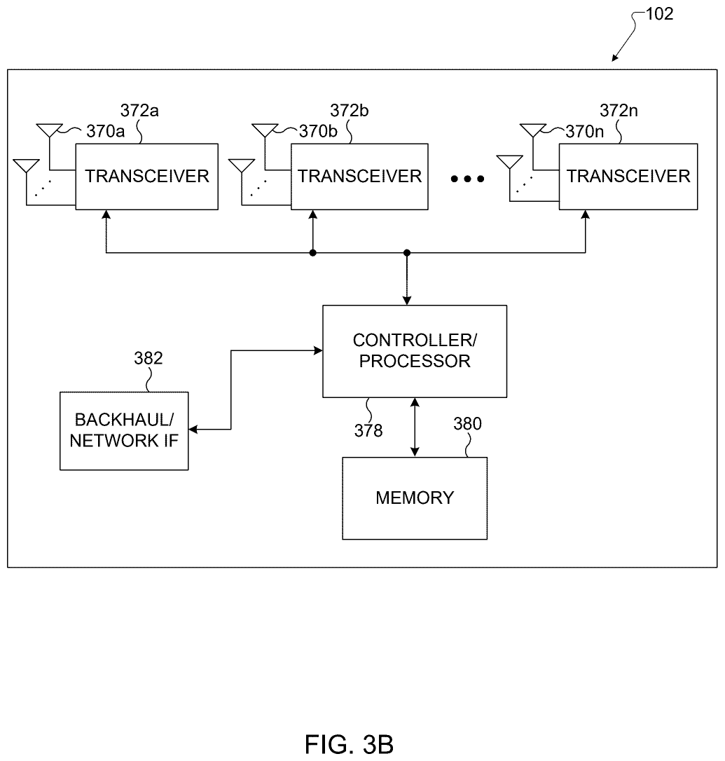

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE initiated lower layer triggered mobility as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support UE initiated lower layer triggered mobility as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary

SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise the term Special Cell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern ⅔, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured Control REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols- PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-Inactivity Timer, by RRC signalling, or by the MAC entity itself upon initiation of a random access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

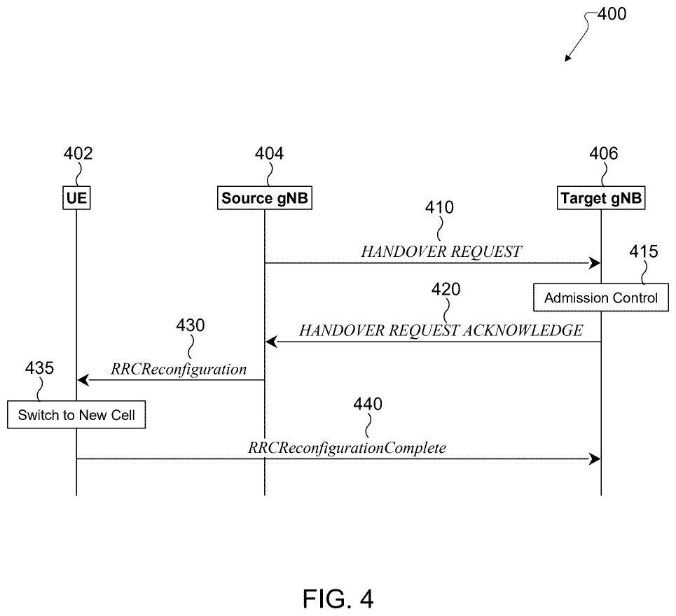

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 4.

FIG. 4 illustrates example signaling procedures 400 for inter-gNB handover according to embodiments of the present disclosure. An embodiment of the signaling procedures illustrated in FIG. 4 are for illustration only. One or more of the components illustrated in FIG. 4 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 4, source gNB 404 initiates handover and issues a HANDOVER REQUEST 410 over an Xn interface to a target gNB 406. Target gNB performs admission control at step 415 and provides a new RRC configuration as part of a HANDOVER REQUEST ACKNOWLEDGE 420. Source gNB 404 provides the RRC configuration to UE 402 by forwarding the RRCReconfiguration message 430 received in the HANDOVER REQUEST ACKNOWLEDGE 420. The RRCReconfiguration message 430 includes at least cell ID and all information required to access the target cell so that the UE 402 can access the target cell without reading system information. For some cases, the information required for contention-based and contention-free random access can be included in RRCReconfiguration message 430. The access information to the target cell may include beam specific information, if any. At step 435, UE 402 moves the RRC connection to target gNB 406 and replies with the RRCReconfigurationComplete message 440. The example of FIG. 4 may be referred to as a network controlled or network initiated handover procedure.

Although FIG. 4 illustrates one example of signaling procedures 400 for inter-gNB handover, various changes may be made to FIG. 4. For example, while shown as a series of steps, various steps in FIG. 4 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early TA acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. The UE may monitor the PDCCH for dynamic scheduling from the target cell upon an LTM cell switch.

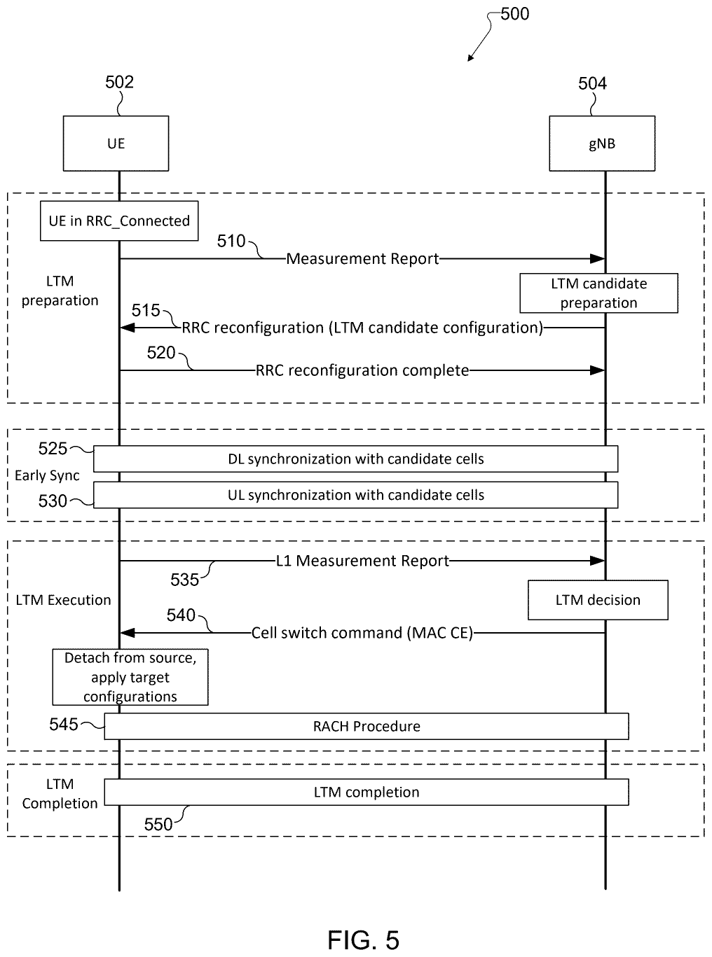

FIG. 5 illustrates an example procedure for LTM 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 5, procedure 500 begins at step 1. At step 510, UE 502, which is in an RRC connected state sends a MeasurementReport message to gNB 504. gNB 504 then decides to configure LTM and initiates candidate cell(s) preparation.

At step 515, gNB 504 transmits an RRCReconfiguration message to UE 502 including the LTM candidate cell configurations of one or multiple candidate cells.

At step 520, UE 502 stores the LTM candidate cell configurations and transmits an RRCReconfigurationComplete message to gNB 504.

At step 525, UE 502 may perform DL synchronization with candidate cell(s) before receiving a cell switch command.

At step 530, if requested by the network, UE 502 performs early TA acquisition with candidate cell(s) before receiving the cell switch command. This is done via contention free random access (CFRA) triggered by a PDCCH order from the source cell, following which UE 502 sends a preamble towards the indicated candidate cell. In order to minimize the data interruption of the source cell due to the CFRA towards the candidate cell(s), UE 502 doesn't receive a RAR for the purpose of TA value acquisition and the TA value of the candidate cell is indicated in the cell switch command. UE 502 doesn't maintain the TA timer for the candidate cell and relies on network implementation to guarantee the TA validity.

At step 535, UE 502 performs L1 measurements on the configured candidate cell(s) and transmits L1 measurement reports to the gNB.

At step 540, gNB 504 decides to execute cell switch to a target cell and transmits a MAC CE triggering cell switch by including the candidate configuration index of the target cell. UE 502 switches to the target cell and applies the configuration indicated by the candidate configuration index.

At step 545, UE 502 performs a random access procedure towards the target cell if UE does not have valid TA of the target cell.

At step 550, UE 502 completes the LTM cell switch procedure by sending a RRCReconfigurationComplete message to the target cell. If UE 502 has performed a RA procedure in step 7, UE 502 considers that the LTM execution is successfully completed when the random access procedure is successfully completed. For RACH-less LTM, UE 502 considers that the LTM execution is successfully completed when the UE determines that the network has successfully received its first UL data. UE 502 determines successful reception of its first UL data by receiving a PDCCH addressing UE 502's C-RNTI in the target cell, which schedules a new transmission following the first UL data.

For LTM, the network may indicate one or more L1 measurement based events based on which UE 502 may initiate LTM execution to a candidate LTM cell without receiving a cell switch command from gNB 504. This procedure may be referred as conditional LTM or UE initiated LTM. A list of one or more candidate LTM cells for conditional LTM or UE initiated LTM may be signaled by gNB 504 in an RRCReconfiguration message (step 515).

Although FIG. 5 illustrates one example procedure for LTM 500, various changes may be made to FIG. 5. For example, while shown as a series of steps, various steps in FIG. 5 could overlap, occur in parallel, occur in a different order, occur any number of times, be omitted, or replaced by other steps.

Early TA acquisition is beneficial for UE initiated LTM, as this allows the UE to perform a RACH less UE initiated LTM switch, which reduces latency. The UE can itself determine the TA, but cases where UE derived TA is supported is limited. Therefore, a network based approach for early TA is desirable. One of the issues with re-using the early TA RA procedure defined for network initiated LTM cell switch is that the network does not send a RAR during the early TA RA procedure. Instead, the network stores the estimated TA and provides the TA in an LTM cell switch command MAC CE. However, in the case of a UE initiated LTM cell switch there is no command from network to perform a cell switch, so the UE does not receive the TA from the network. Various embodiments of the present disclosure, discussed in more detail below, overcome these limitations by having the network provide the TA to the UE before a UE initiated LTM cell switch.

Under existing LTM procedures, the UE receives an LTM configuration via RRC, wherein the LTM configuration includes configuration of one or more LTM candidate cells. However, the LTM configuration does not indicate which LTM candidate cell(s) for which UE initiated LTM is allowed. Various embodiments of the present disclosure, discussed in more detail below, overcome these limitations by having the network provide parameters to the UE where the UE can determine whether a UE initiated LTM is allowed with an LTM candidate cell.

Under existing LTM procedures, for a network initiated LTM cell switch, a TCI state/beam is indicated in an LTM cell switch MAC CE. The UE uses this beam to monitor the PDCCH and/or select a CG resource for UL transmission. However, in the case of a UE initiated LTM cell switch, there is no command from network to perform a cell switch, so the UE does not know how to select a CG resource for the UE initiated LTM cell switch. Various embodiments of the present disclosure, discussed in more detail below, overcome these limitations by providing mechanisms for the UE to determine a CG resource for a UE initiated LTM cell switch.

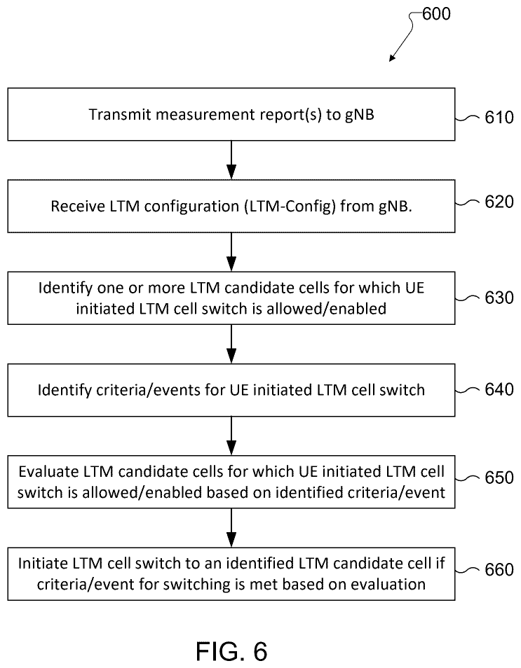

FIG. 6 illustrates an example method for UE initiated LTM 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for UE initiated LTM could be used without departing from the scope of this disclosure.

In the example of FIG. 6, method 600 begins at step 610. At step 610, a UE (such as UE 116 of FIG. 1) sends layer 1 and/or layer 3 measurement report(s) (e.g., in a MeasurementReport message or MAC CE) to a gNB (such as BS 102 of FIG. 1). After receiving the measurement report(s), the gNB decides to configure LTM (network initiated and/or UE initiated) for the UE and initiates LTM preparation.

At step 620, the gNB transmits an RRCReconfiguration message to the UE including the LTM configuration (LTM-Config). The LTM configuration is configured per CG, and the RRCReconfiguration message may include an LTM configuration for the MCG and/or SCG. After receiving the RRCReconfiguration message, the UE stores the LTM candidate cell configurations and transmits an RRCReconfigurationComplete message to the gNB.

At step 630, the UE identifies one or more LTM candidate cells for which UE initiated LTM cell switch is allowed/enabled.

At step 640, the UE identifies criteria/events for a UE initiated LTM cell switch.

At step 650, the UE evaluates the identified LTM candidate cells for which a UE initiated LTM cell switch is allowed/enabled based on the identified criteria/event.

At step 660, the UE initiates/performs an LTM cell switch to an identified LTM candidate cell if the criteria/event for switching is met based on the evaluation.

Although FIG. 6 illustrates one example method for UE initiated LTM 600, various changes may be made to FIG. 6. For example, while shown as a series of steps, various steps in FIG. 6 could overlap, occur in parallel, occur in a different order, occur any number of times, be omitted, or replaced by other steps.

In some embodiments of LTM as described herein, a UE may receive an LTM configuration (LTM-Config) from a gNB (for example, at step 620 of FIG. 6). In some embodiments, the LTM-Config may include a list of one or more LTM candidate cell configurations. In some embodiments, the list may be common for UE initiated and network initiated LTM. The LTM candidate cell configuration(s) may include physical cell id(s) of the LTM candidate cell(s). The LTM candidate cell configuration may include LTM candidate ID(s). An LTM candidate ID uniquely identifies an LTM candidate configuration. An LTM candidate cell configuration may include an RRCReconfiguration of the LTM candidate cell.

In some embodiments, criteria/events for UE initiated LTM switch can be included in the LTM-Config. In some embodiments, the criteria/events for UE initiated LTM switch can per LTM candidate cell configuration. The criteria/events may include reference signal(s) (e.g., SSB, CSI RS etc.) to measure, a measurement quantity (e.g., RSRP, RSRQ, SINR, RSSI etc.), a measurement threshold, events such as a measurement quantity of a candidate is greater than a threshold, a measurement quantity of a candidate is greater than a threshold and measurement quantity of the serving cell is less than threshold, a measurement quantity of a candidate is offset greater than a measurement quantity of the serving cell and so on.

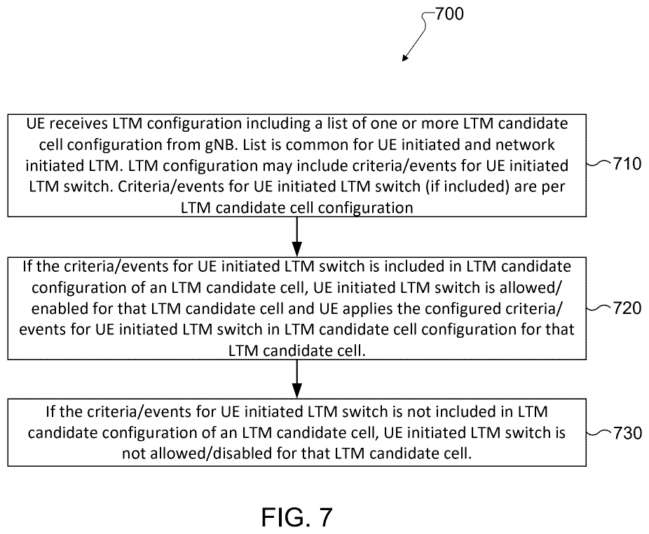

In some embodiments, the network can control for which LTM candidate cells UE initiated LTM cell switch is allowed by including/not including criteria/events for UE initiated LTM switch per LTM candidate cell configuration. In some embodiments, the UE can identify the LTM candidate cell(s) and criteria/events for UE initiated LTM cell switch as shown in FIG. 7.

FIG. 7 illustrates an example method for identifying allowed LTM candidate cells 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a method for identifying allowed LTM candidate cells could be used without departing from the scope of this disclosure.

In the example of FIG. 7, method 700 begins at step 710. At step 710, a UE (such as UE 116 of FIG. 1) receives an LTM-Config from a gNB (such as BS 102 of FIG. 1). The LTM-Config includes a list of one or more LTM candidate cell configurations. This list is common for UE initiated and network initiated LTM. Each LTM candidate configuration in the list corresponds to an LTM candidate cell. The LTM candidate cell configuration includes a physical cell ID of the LTM candidate cell. The LTM candidate cell configuration includes an LTM candidate ID. The LTM candidate ID uniquely identifies an LTM candidate configuration. The LTM candidate cell configuration includes a RRCReconfiguration of the LTM candidate cell. In some embodiments, the LTM configuration may include criteria/events for UE initiated LTM switch. The criteria/events may include reference signal(s) (e.g. SSB, CSI RS etc.) to measure, a measurement quantity (e.g. RSRP, RSRQ, SINR, RSSI etc.), a measurement threshold, events such as a measurement quantity of the candidate is greater than a threshold, a measurement quantity of the candidate is greater than a threshold and a measurement quantity of the serving cell is less than threshold, a measurement quantity of the candidate is offset greater than a measurement quantity of the serving cell and so on. Criteria/events for UE initiated LTM switch (if included) are per LTM candidate cell configuration.

At step 720, if the criteria/events for UE initiated LTM switch are included in the LTM candidate configuration of an LTM candidate cell, a UE initiated LTM switch is allowed/enabled for that LTM candidate cell and the UE applies the configured criteria/events for UE initiated LTM switch in the LTM candidate cell configuration for that LTM candidate cell.

At step 730, if the criteria/events for UE initiated LTM switch is not included in the LTM candidate configuration of an LTM candidate cell, a UE initiated LTM switch is not allowed/disabled for that LTM candidate cell.

Although FIG. 7 illustrates one example method for identifying allowed LTM candidate cells 700, various changes may be made to FIG. 7. For example, while shown as a series of steps, various steps in FIG. 7 could overlap, occur in parallel, occur in a different order, occur any number of times, be omitted, or replaced by other steps.

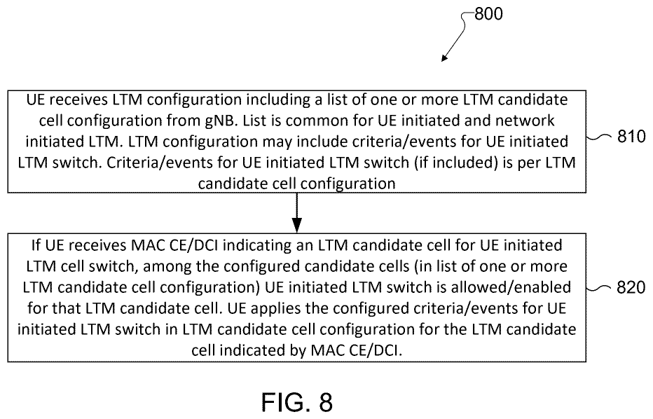

In some embodiments, the gNB can indicate to the UE by a MAC CE/DCI one or more LTM candidate cells among the configured candidate cells (in a list of one or more LTM candidate cell configurations) that the UE can perform UE initiated LTM, e.g., by a bitmap, or LTM candidate ID. For example, in some embodiments, each bit (from most significant bit [MSB] to least significant bit [LSB] or from LSB to MSB) in a bitmap can be mapped to LTM candidate cells in list of one or more LTM candidate cell configurations. In some embodiments, each bit (from MSB to LSB or from LSB to MSB) in the bitmap can be mapped to the LTM candidate cells in the list of one or more LTM candidate cell configurations in ascending or descending order of LTM candidate ID. In some embodiments, each bit (from MSB to LSB or from LSB to MSB) in the bitmap can be mapped to LTM candidate cells for which criteria/events for UE initiated LTM switch are included in the list of one or more LTM candidate cell configurations. In some embodiments, each bit (from MSB to LSB or from LSB to MSB) in the bitmap can be mapped to LTM candidate cells for which criteria/events for UE initiated LTM switch are included in the list of one or more LTM candidate cell configurations, in ascending or descending order of LTM candidate ID. In some embodiments, the UE can identify the LTM candidate cell(s) and criteria/events for UE initiated LTM cell switch as shown in FIG. 8.

FIG. 8 illustrates another example method for identifying allowed LTM candidate cells 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for identifying allowed LTM candidate cells could be used without departing from the scope of this disclosure.

In the example of FIG. 8, method 800 begins at step 810. At step 810, a UE (such as UE 116 of FIG. 1) receives an LTM-Config from a gNB (such as BS 102 of FIG. 1). The LTM-Config includes a list of one or more LTM candidate cell configurations. This list is common for UE initiated and network initiated LTM. Each LTM candidate configuration in the list corresponds to an LTM candidate cell. The LTM candidate cell configuration includes physical cell ID of the LTM candidate cell. LTM candidate cell configuration includes an LTM candidate ID. The LTM candidate ID uniquely identifies an LTM candidate configuration. The LTM candidate cell configuration includes a RRCReconfiguration of the LTM candidate cell. In some embodiments, the LTM configuration may include criteria/events for UE initiated LTM switch. The criteria/events may include reference signal(s) (e.g. SSB, CSI RS etc.) to measure, a measurement quantity (e.g. RSRP, RSRQ, SINR, RSSI etc.), a measurement threshold, events such as a measurement quantity of the candidate is greater than a threshold, a measurement quantity of the candidate is greater than a threshold and a measurement quantity of the serving cell is less than a threshold, a measurement quantity of the candidate is offset greater than a measurement quantity of the serving cell and so on. Criteria/events for UE initiated LTM switch (if included) are per LTM candidate cell configuration.

At step 820, if the UE receives a MAC CE/DCI indicating an LTM candidate cell for UE initiated LTM cell switch, among the configured candidate cells (in the list of one or more LTM candidate cell configurations) UE initiated LTM switch is allowed/enabled for that LTM candidate cell. The UE applies the configured criteria/events for UE initiated LTM switch in the LTM candidate cell configuration for the LTM candidate cell indicated by the MAC CE/DCI.

Although FIG. 8 illustrates one example method for identifying allowed LTM candidate cells 800, various changes may be made to FIG. 8. For example, while shown as a series of steps, various steps in FIG. 8 could overlap, occur in parallel, occur in a different order, occur any number of times, be omitted, or replaced by other steps.

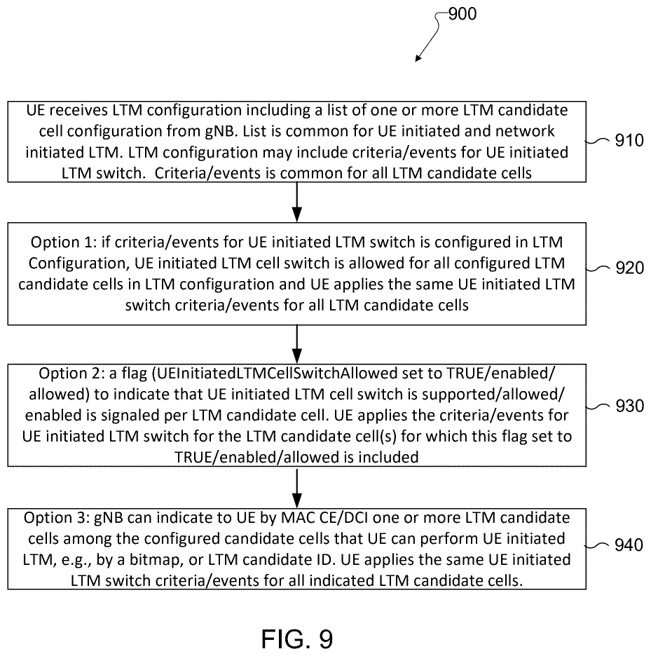

In some embodiments, the UE can identify the LTM candidate cell(s) and criteria/events for UE initiated LTM cell switch as shown in FIG. 9.

FIG. 9 illustrates another example method for identifying allowed LTM candidate cells 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for identifying allowed LTM candidate cells could be used without departing from the scope of this disclosure.

In the example of FIG. 9, method 900 begins at step 910. At step 910, a UE (such as UE 116 of FIG. 1) receives an LTM-Config. The LTM-Config includes a list of one or more LTM candidate cell configurations. This list is common for UE initiated and network initiated LTM. Each LTM candidate configuration in the list corresponds to an LTM candidate cell. The LTM candidate cell configuration includes a physical cell ID of the LTM candidate cell. The LTM candidate cell configuration includes an LTM candidate ID. The LTM candidate ID uniquely identifies an LTM candidate configuration. The LTM candidate cell configuration includes a RRCReconfiguration of the LTM candidate cell. In some embodiments, the LTM configuration may include criteria/events for UE initiated LTM switch. The criteria/events may include reference signal(s) (e.g. SSB, CSIRS etc.) to measure, a measurement quantity (e.g. RSRP, RSRQ, SINR, RSSI etc.), a measurement threshold, events such as a measurement quantity of the candidate is greater than a threshold, a measurement quantity of the candidate is greater than a threshold and a measurement quantity of the serving cell is less than threshold, a measurement quantity of the candidate is offset greater than a measurement quantity of the serving cell and so on. Criteria/events for UE initiated LTM switch (if included) are commonly included in LTM configuration (LTM-Config).

In some embodiments, at step 920, if criteria/events for UE initiated LTM switch are configured in the LTM-Config, UE initiated LTM cell switch is allowed for all configured LTM candidate cells in the LTM-Config, and the UE applies the same UE initiated LTM switch criteria/events for all LTM candidate cells.

In some embodiments, at step 930, a flag (UEInitiatedLTMCellSwitchAllowed set to TRUE/enabled/allowed) to indicate that UE initiated LTM cell switch is supported/allowed/enabled is signaled per LTM candidate cell. The UE applies the criteria/events for UE initiated LTM switch for the LTM candidate cell(s) for which this flag set to TRUE/enabled/allowed is included.

In some embodiments, at step 940, the gNB can indicate to the UE by a MAC CE/DCI (e.g., by a bitmap, or LTM candidate ID) one or more LTM candidate cells among the configured candidate cells with which the UE can perform a UE initiated LTM. For example, if the MAC CE/DCI includes a bitmap, each bit (from MSB to LSB or from LSB to MSB) in the bitmap can be mapped to the LTM candidate cells in the list of one or more LTM candidate cell configurations in ascending or descending order of LTM candidate ID. The UE applies the same UE initiated LTM switch criteria/events for all indicated LTM candidate cells.

Although FIG. 9 illustrates one example method for identifying allowed LTM candidate cells 900, various changes may be made to FIG. 9. For example, while shown as a series of steps, various steps in FIG. 9 could overlap, occur in parallel, occur in a different order, occur any number of times, be omitted, or replaced by other steps.

In some embodiments, an LTM-Config may include a list of one or more LTM candidate cell configurations for network initiated LTM and/or a list of one or more LTM candidate cell configurations for UE initiated LTM. In some embodiments, the list of LTM candidate cells for UE initiated LTM and Network initiated LTM are separate. In some embodiments, each LTM candidate configuration in the list corresponds to an LTM candidate cell. The LTM candidate cell configuration may include physical cell id(s) of the LTM candidate cell(s). The LTM candidate cell configuration may include an LTM candidate ID. An LTM candidate ID identifies an LTM candidate configuration. The LTM candidate cell configuration may include an RRCReconfiguration of the LTM candidate cell.

Criteria/events may include measurement quantity (e.g., RSRP, RSRQ, SINR, RSSI etc.), measurement threshold, events such as a measurement quantity of a candidate is greater than a threshold, a measurement quantity of a candidate is greater than a threshold and a measurement quantity of the serving cell is less than a threshold, a measurement quantity of a candidate is offset greater than a measurement quantity of the serving cell, and so on.

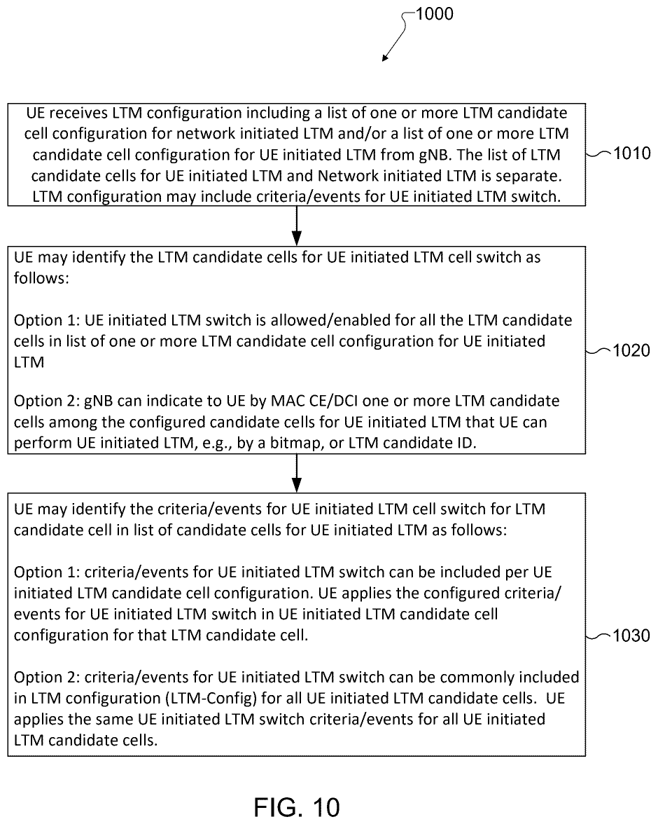

In some embodiments, the UE can identify the LTM candidate cell(s) and criteria/events for UE initiated LTM cell switch as shown in FIG. 10.

FIG. 10 illustrates another example method for identifying allowed LTM candidate cells 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for identifying allowed LTM candidate cells could be used without departing from the scope of this disclosure.

In the example of FIG. 10, method 1000 begins at step 1010. At step 1010, a UE (such as UE 116 of FIG. 1) receives an LTM-Config from a gNB (such as BS 102 of FIG. 1). The LTM-Config includes a list of one or more LTM candidate cell configurations for network initiated LTM and/or a list of one or more LTM candidate cell configurations for UE initiated LTM. The lists of LTM candidate cells for UE initiated LTM and Network initiated LTM are separate. In some embodiments, the LTM configuration may include criteria/events for UE initiated LTM switch.

At step 1020, the UE may identify the LTM candidate cells for UE initiated LTM cell switch. In some embodiments, UE initiated LTM switch is allowed/enabled for all the LTM candidate cells in the list of one or more LTM candidate cell configurations for UE initiated LTM. In some embodiments, the gNB can indicate to the UE by a MAC CE/DCI (e.g., by a bitmap, or LTM candidate ID) one or more LTM candidate cells among the configured candidate cells for UE initiated LTM. For example, if the MAC CE/DCI includes a bitmap, each bit (from MSB to LSB or from LSB to MSB) in the bitmap can be mapped to the LTM candidate cells in the list of one or more LTM candidate cell configurations for UE initiated LTM. Each bit (from MSB to LSB or from LSB to MSB) in the bitmap can be mapped to the LTM candidate cells in the list of one or more LTM candidate cell configurations for UE initiated LTM in ascending or descending order of the LTM candidate IDs.

At step 1030, the UE may UE may identify the criteria/events for UE initiated LTM cell switch for LTM candidate cell in list of candidate cells for UE initiated LTM. In some embodiments, the criteria/events for UE initiated LTM switch can be included per UE initiated LTM candidate cell configuration. In these embodiments, the UE applies the configured criteria/events for UE initiated LTM switch in the UE initiated LTM candidate cell configuration for that LTM candidate cell. In some embodiments, the criteria/events for UE initiated LTM switch can be commonly included in the LTM-Config for all the UE initiated LTM candidate cells. In these embodiments, the UE applies the same UE initiated LTM switch criteria/events for all the UE initiated LTM candidate cells.

Although FIG. 10 illustrates one example method for identifying allowed LTM candidate cells 1000, various changes may be made to FIG. 10. For example, while shown as a series of steps, various steps in FIG. 10 could overlap, occur in parallel, occur in a different order, occur any number of times, be omitted, or replaced by other steps.

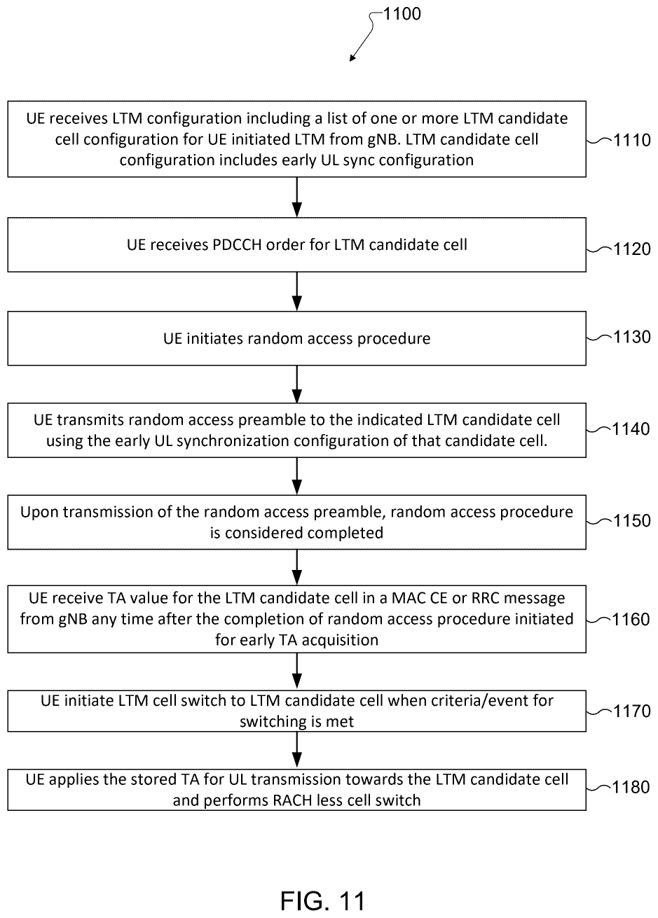

As noted above, early TA acquisition can be beneficial for UE initiated LTM to perform RACH less UE initiated LTM switch to reduce latency. In some embodiments, the TA can be acquired for one or more candidate cells for UE initiated LTM after receiving the LTM configuration and before the LTM cell switch. An example of such an embodiment is shown in FIG. 11.

FIG. 11 illustrates another example method for UE initiated LTM 1100 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for UE initiated LTM could be used without departing from the scope of this disclosure.

In the example of FIG. 11, method 1100 begins at step 1110. At step 1110, a UE (such as UE 116 of FIG. 1) receives an LTM configuration from a gNB (such as BS 102 of FIG. 1). In some embodiments, the LTM configuration can be received in RRCReconfiguration message. The LTM configuration includes an LTM candidate configuration for one or more LTM candidate cells. The LTM candidate configuration also includes an early UL synchronization configuration for NUL and/or SUL. After receiving the LTM configuration, the UE stores the received configuration and transmits an RRCReconfigurationComplete message to the gNB.

In some embodiments, the LTM candidate cell is associated with multiple TRPs/TAGs. In some embodiments, the number of multiple TRPs/TAGs can be 2. A TAG ID of each TAGs is included in the LTM configuration of the candidate cell. One of these TAG/TAG IDs can be referred as a first TAG (identified by TAG index 0) and another can be referred to as a second TAG (identified by TAG index 1). The LTM configuration of the LTM candidate cell may include list of TCI states, wherein each TCI state is associated to one of the TAGs of the LTM candidate cell.

Upon receiving the LTM configuration: the UE identifies one or more LTM candidate cells for which UE initiated LTM cell switch is allowed/enabled; the UE identifies criteria/events for UE initiated LTM cell switch; and the UE evaluates identified LTM candidate cells for which UE initiated LTM cell switch is allowed/enabled based on an identified criteria/event.

At step 1120, the UE may receive a PDCCH order from the gNB. The PDCCH order indicates one of the LTM candidate cells.

At step 1130, the UE initiates a random access procedure based on the received PDCCH order. This random access procedure is for early TA acquisition for the candidate cell.

At step 1140, the UE transmits a random access preamble to the indicated LTM candidate cell using the early UL synchronization configuration of that candidate cell.

At step 1150, upon transmission of the random access preamble, the random access procedure is considered completed. The candidate cell determines the TA value based on the received random access preamble. Then the candidate cell or DU of the candidate cell sends the estimated TA to the gNB/DU (or source gNB/DU) of the serving cell. If the candidate cell is not configured for UE initiated LTM cell switch, gNB/DU (or source gNB/DU) of serving cell may send the TA value later to the UE in cell switch command MAC CE when the gNB decides to switch to the candidate cell.

In some embodiments, at step 1160, if the candidate cell is configured for UE initiated LTM cell switch, the gNB/DU (or source gNB/DU) of the serving cell may send the TA value in a MAC CE or RRC message to the UE. The MAC CE or RRC message indicates an LTM candidate cell identity and TA value. The UE stores the received TA for the indicated candidate LTM cell. The UE may receive the TA value in a MAC CE or RRC message from the gNB any time after the completion of the random access procedure initiated for early TA acquisition for the candidate cell. The gNB may send the TA value in a MAC CE or RRC message any time after the completion of the random access procedure initiated for early TA acquisition for the candidate cell, or before the completion of the random access procedure. Note that this MAC CE is different from a cell switch command MAC CE which is used by the network for a network initiated cell switch. This MAC CE does not trigger a cell switch and provides the TA for the LTM candidate cell which the UE can use in case a UE initiated cell switch is triggered later. The LTM candidate cell identity can be an LTM candidate ID (or LTM configuration ID of the LTM candidate cell) or a bitmap indicated in the MAC CE or RRC message. For example, if the MAC CE or RRC message includes a bitmap, each bit (from MSB to LSB or from LSB to MSB) in the bitmap is mapped to LTM candidate IDs (or LTM configuration IDs) in ascending order of the LTM candidate IDs. The LTM Configuration ID indicates the index of the candidate configuration of the LTM candidate cell corresponding to Itm-CandidateId minus 1, where Itm-CandidateId is received in the configuration of LTM candidate cell. Alternately, the LTM Configuration ID indicates the index of the candidate configuration of the LTM candidate cell corresponding to Itm-CandidateId, where Itm-CandidateId is received in the configuration of the LTM candidate cell.

In some embodiments, if the LTM candidate cell for UE initiated LTM cell switch is configured with multiple (or two) TAGs/TRPs, the TA value in the MAC CE or RRC message for the LTM candidate cell from the gNB/DU (or source gNB/DU) of the serving cell is associated with or applied to the TAG corresponding to the SSB selected during the random access procedure initiated for early TA of the LTM candidate cell. The SSB selected can be received in the PDCCH order initiating the random access procedure for early TA of the LTM candidate cell. The TAG corresponding to the SSB is the TAG of the joint TCI state (from the list ltm-DL-OrJointTCI-State ToAddModList) if unifiedTCI-State Type is set to ‘joint’ in the LTM configuration of the LTM candidate cell or the UL TCI state (from the list ltm-UL-TCI-StatesToAddModList) if unifiedTCI-StateType is set to ‘separate’ in the LTM configuration of LTM candidate cell) associated with the SSB (or associated with an RS QCLed with the SSB). The mapping of TCI states to TAGs and mapping of TCI states to SSBs is signaled in the LTM configuration of LTM candidate cell. Itm-UL-TCI-StatesToAddModList and Itm-DL-OrJointTCI-StateToAddModList are received at step 1110 in the LTM configuration of the LTM candidate cell.

In some embodiments, if the LTM candidate cell for the UE initiated LTM cell switch is configured with multiple (or two) TAGs/TRPs, the TA value in the MAC CE or RRC message for the LTM candidate cell from the gNB/DU (or source gNB/DU) of the serving cell, is associated with or applied to the TAG indicated in the MAC CE or RRC message. A TAG indication (TI) can be included in the MAC CE or RRC message. If two TAGs are configured for the LTM candidate cell, the TI field indicates one of the two TAGs (tag-Id and tag2-Id) and to which the Timing Advance Command is applied. The TI field set to 0 indicates the tag-Id and the TI field set to 1 indicates the tag2-Id of the LTM candidate cell. Alternately, the TI field set to 1 indicates the tag-Id and the TI field set to 0 indicates the tag2-Id of the LTM candidate cell.

In some embodiments, if the LTM candidate cell for UE initiated LTM cell switch is configured with multiple (or two) TAGs/TRPs, the TA value in the MAC CE or RRC message for the LTM candidate cell from the gNB/DU (or source gNB/DU) of the serving cell is associated with a joint TCI state/UL TCI state included in this MAC CE or RRC message or joint TCI state/UL TCI state signaled to the UE in a separate MAC CE (e.g. a Candidate Cell TCI States Activation/Deactivation MAC CE). In some embodiments, if unifiedTCI-StateType is set to ‘separate’ in the LTM configuration of the LTM candidate cell, the UE applies the TA for the TAG which is configured as associated with the UL TCI state (i.e., the TCI state indicated by the UL TCI state ID field) and starts the corresponding TAT. A list of UL TCI states is configured by the list ltm-UL-TCI-StatesToAddModList in the LTM configuration of the LTM candidate cell. A UL TCI state in the list is identified by TCI-UL-StateId in Itm-UL-TCI-StatesToAddModList. A TAG (e.g. first or second TAG) associated with the UL TCI state is also indicated in Itm-UL-TCI-StatesToAddModList. The UL TCI state ID is set to the TCI-UL-StateId of an UL TCI State. In some embodiments, if unifiedTCI-StateType is set to ‘joint’ in the LTM configuration of the LTM candidate cell, the UE applies the TA for the TAG which is configured as associated with the joint TCI state (i.e., the TCI state indicated by the TCI state ID field) indicated in the MAC CE triggering the cell switch and starts the corresponding TAT. A list of joint TCI states is configured by the list ltm-DL-OrJointTCI-StateToAddModList in the LTM configuration of the LTM candidate cell. Each joint TCI state in list is identified by TCI-StateId in Itm-DL-OrJointTCI-StateToAddModList. The TAG (e.g. first or second TAG) associated with the joint TCI state is also in Itm-DL-OrJointTCI-StateToAddModList. The TCI state ID is set to TCI-StateId of a joint TCI State.

In some embodiments, a TA for multiple LTM candidate cells can be sent to the UE by GNB in the MAC CE or RRC message. In some embodiments, a candidate timing alignment timer (TAT)) for the LTM candidate cell can be signaled (e.g., in early an UL synchronization configuration or LTM configuration) by the gNB for the delivered TA. The Candidate TAT for an LTM candidate cell can be (re) started when the TA for the LTM candidate cell is received in the MAC CE. Upon candidate TAT expiry, the UE discards the corresponding TA. In some embodiments, if the TAT is running for the LTM candidate cell (or for a TAG of the LTM candidate cell) and the TA for the LTM candidate cell (or for the TAG of the LTM candidate cell) is a received MAC CE or RRC message, the UE restarts the TAT and stores the TA received. Later if the LTM cell switch to the candidate cell is initiated, the UE applies the latest received and valid TA (e.g. for which TAT is still running) for the candidate cell.

In some embodiments, at step 1160, if the candidate cell is configured for UE initiated LTM cell switch, the gNB/DU (or source gNB/DU) of the serving cell may send the TA value in a MAC CE or RRC message to the UE. The MAC CE or RRC message indicates a timing advance group (TAG) of the LTM candidate cell and TA value. The TAG of the LTM candidate cell is provided in an early UL synchronization configuration or LTM configuration. The UE stores the received TA for the indicated TAG. The UE may receive the TA value in a MAC CE or RRC message from the gNB any time after the completion of the random access procedure initiated for early TA acquisition for the candidate cell. The gNB may send the TA value in a MAC CE or RRC message any time after the completion of the random access procedure initiated for early TA acquisition for the candidate cell. In some embodiments, a TA for multiple TAGs can be sent to the UE by the gNB in the MAC CE or RRC message. In some embodiments, a candidate TAT for the LTM candidate cell/TAG can be signaled (e.g., in an early UL synchronization configuration or LTM configuration) by the gNB for the delivered TA. The candidate TAT for LTM candidate cell/TAG can be (re) started when the TA for the LTM candidate cell/TAG is received in the MAC CE. Upon candidate TAT expiry, the UE discards the corresponding TA.

In case that the TA of the LTM candidate cell is the same as one of the serving cell(s):
The UE can identify whether the TA of the LTM candidate cell is the same as one of the serving cells by comparing the TAG of the LTM candidate cell with the TAG of the serving cells(s). The TAG for the LTM candidate cell can be configured in an early UL synchronization configuration or LTM configuration.
The Network can indicate whether the TA of the LTM candidate cell is the same as one of the serving cells in the MAC CE. The serving cell index can be included in the MAC CE.
Network can whether the TA of the LTM candidate cell is the same as one of the serving cells via RRC e.g., in an early TA config. The serving cell index can be included in the early TA config.

At step 1170, the UE initiates an LTM cell switch to an LTM candidate cell when criteria/event for switching is met.

At step 1180, the UE applies the stored TA (i.e., a valid TA for which the TAT is still running) for UL transmission towards the LTM candidate cell and performs a RACH less LTM cell switch.

Although FIG. 11 illustrates one example method for UE initiated LTM 1100, various changes may be made to FIG. 11. For example, while shown as a series of steps, various steps in FIG. 11 could overlap, occur in parallel, occur in a different order, occur any number of times, be omitted, or replaced by other steps.

As noted above, under existing LTM procedures, in the case of a UE initiated LTM cell switch, there is no command from the network to perform the cell switch, so the UE does not know how to select a CG resource for the UE initiated LTM cell switch. Various embodiments of the present disclosure provide mechanisms for the UE to determine a CG resource for a UE initiated LTM cell switch.

In some embodiments, a CG resource configuration for UE initiated LTM cell switch can be received in an LTM candidate configuration. In some embodiments the CG resources for a RACH less LTM cell switch can be common for a UE initiated and network initiated LTM cell switch. In some embodiments, CG resources can be separately signaled for a RACH less UE initiated and network initiated LTM cell switch.

In some embodiments, upon initiation of a UE initiated RACH less LTM cell switch, the UE selects the SSB (amongst the SSBs associated with the CG resources) with a synchronization signal-reference signal received power (SS-RSRP) above a threshold. The UE then selects the CG resource corresponding to this SSB for the first UL transmission. In some embodiments, in case there is no SSB with an SS-RSRP above the threshold (amongst the SSBs associated with the CG resources), the UE may perform a RACH based UE initiated LTM cell switch or the UE can select a best SSB (amongst the SSBs associated with CG the resources). Upon transmitting an UL in a CG resource, the UE may monitor the PDCCH addressed to the C-RNTI QCLed with the SSB selected corresponding to the CG resource for UL transmission.

Note that a dynamic grant (DG) based RACH less LTM cell switch cannot work for a UE initiated LTM cell switch, as the target cell does not know when to start transmitting a PDCCH for a DG. In some embodiments, if the network supports RACH less UE initiated LTM cell switches, CG resources are configured. In some embodiments, if CG resources are not configured or a valid TA is not available for the target (i.e., LTM candidate cell to which the UE is switching), the UE performs a RACH based UE initiated LTM cell switch. Note that this is different from a Network initiated LTM cell switch, as whether CG resources are configured is not the basis for a Network initiated RACH less LTM cell switch.

In some embodiments, PDCCH monitoring occasions may be configured for RACH less UE initiated LTM Cell switch, wherein the SSBs transmitted in the target are mapped to the PDCCH monitoring occasions. In some embodiments, the UE selects an SSB with a synchronization signal-reference signal received power (SS-RSRP) above a threshold and monitors the PDCCH addressed to a C-RNTI in a PDCCH monitoring occasion corresponding to the selected SSB. Alternately, the UE may monitor the PDCCH addressed to a C-RNTI in a PDCCH monitoring occasion corresponding to the SSB associated with activated TCI state received in a MAC CE.

In some embodiments, during the RACH less UE initiated LTM cell switch or while the RACH less UE initiated LTM cell switch is ongoing and CG resources are configured for this cell switch, if the TAT timer for the LTM candidate/target cell to which the switch is being performed expires, the UE stops using the CG resources (or releases the CG resources) and performs a RACH based UE initiated LTM cell switch (i.e., a UE initiated random access procedure towards the LTM candidate/target cell to which the switch is being performed).

In some embodiments, during the RACH less UE initiated LTM cell switch or while the RACH less UE initiated LTM cell switch is ongoing and CG resources are configured for this cell switch, if the TAT timer for the LTM candidate/target cell to which the switch is being performed expires and the UE has not received a PDCCH addressed to a C-RNTI scheduling a new UL grant or new DL transmission, the UE stops using the CG resources (or releases the CG resources) and performs a RACH based UE initiated LTM cell switch (i.e., a UE initiated random access procedure towards the LTM candidate/target cell to which the switch is being performed).

In some embodiments, during the RACH less UE initiated LTM cell switch or while the RACH less UE initiated LTM cell switch is ongoing and CG resources are configured for this cell switch, if the TAT timer for the LTM candidate/target cell to which the switch is being performed expires and the UE has not received a PDCCH addressed to a C-RNTI scheduling a new UL grant (for the same HARQ process as the HARQ process used by the UE to transmit the first UL transmission to the LTM candidate/target cell or new DL transmission, the UE stops using the CG resources (or releases the CG resources) and performs a RACH based UE initiated LTM cell switch (i.e., a UE initiated random access procedure towards the LTM candidate/target cell to which the switch is being performed).

In some embodiments, if a UE initiated LTM cell switch is initiated within a defined interval after receiving the LTM configuration, the UE may start monitoring the PDCCH upon initiation of the RACH less LTM cell switch. In this case even if CG resources are not configured, the RACH less LTM cell switch can be performed if the UE has valid TA. In some embodiments, the start of the defined interval can be at an offset from the time the UE receives the LTM configuration. In some embodiments, the start of the defined interval can be the time the UE receives the LTM configuration. In some embodiments, the end of the defined interval with respect to start is configured.

In some embodiments, if a UE initiated LTM cell switch is initiated within a defined interval (and a time based event is configured) after receiving the LTM configuration, if a valid TA is not available for the target (i.e., the LTM candidate cell to which the UE is switching), the UE performs a RACH based UE initiated LTM cell switch. Otherwise, if the a valid TA is available for the target, the UE performs a RACH less UE initiated LTM cell switch.

In some embodiments, if a UE initiated LTM cell switch is initiated within a defined interval (and a time based event is configured) after receiving the LTM configuration, if CG resources are not configured or a valid TA is not available for the target (i.e., the LTM candidate cell to which the UE is switching), the UE performs a RACH based UE initiated LTM cell switch. Otherwise, if CG resources are configured and a valid TA is available for the target, the UE performs a RACH based UE initiated LTM cell switch.

In some embodiments, when a criterion/event for switching to an LTM candidate cell is met, the UE sends/transmits an LTM cell switch notification (request) to the source serving cell. The LTM cell switch notification can be a MAC CE or an RRC message or a notification transmitted on a PUCCH resource (the PUCCH resource or SR resource can be configured in a serving cell configuration for this notification). The notification may include a candidate configuration ID, one or more or a best DL/UL/Joint TCI state of the LTM candidate cell, one or more or a best SSB index(s)/CSI RS(s) with signal quality (e.g., RSRP) above a configured threshold, L1 measurement result of the LTM candidate cell, etc. In some embodiments, the notification may indicate whether the UE has a valid TA for the LTM candidate cell.

In some embodiments, upon receiving an acknowledgment of this notification, the UE performs a RACH or RACH less cell switch (or the UE starts an uplink transmission) towards the LTM candidate cell. The acknowledgment of this notification can be a MAC CE or PDCCH addressed to a C-RNTI scheduling a new transmission (UL grant or DL TB) for the same HARQ process as the HARQ process used for transmitting the cell switch notification or LTM Cell switch command MAC CE.

In some embodiments, if an acknowledgment of this notification is received, the UE can perform a RACH less LTM cell switch to the LTM candidate cell, provided the UE has a valid TA (or provided the UE has a valid TA and CG resources for [UE initiated] RACH less LTM cell switch are configured). The TA may be received in the acknowledgment. During the RACH less LTM cell switch, the UE may use the SSB/TCI state/UL TCI state indicated in the notification (or in the acknowledgment, if included) for selecting the CG resource for uplink transmission (included in the RRCReconfiguration complete message) to the LTM candidate cell. In some embodiments, if an acknowledgment of this notification is not received, the UE can perform a RACH based LTM cell switch to the LTM candidate cell. In some embodiments, if an acknowledgment of this notification is not received, the UE can refrain from performing an LTM cell switch to the LTM candidate cell.

In some embodiments, the UE can start a timer after transmitting the cell switch notification, and if an acknowledgment of this notification is not received before the timer expires (or while the timer is running), the UE can perform RACH based LTM cell switch to LTM candidate cell. In some embodiments, if an acknowledgment of this notification is received before the timer expires (or while the timer is running), the UE can perform a RACH less LTM cell switch to LTM candidate cell, provided the UE has a valid TA (or provided the UE has a valid TA and CG resources for [UE initiated] RACH less LTM cell switch are configured). During the RACH less LTM cell switch, the UE may use the SSB/TCI state/UL TCI state indicated in the notification for selecting the CG resource for uplink transmission (included in the RRCReconfiguration complete message) to the LTM candidate cell.

In some embodiments, if an acknowledgment of this notification is not received, the UE can retransmit the notification. In some embodiments, if the acknowledgment is not received even after transmitting the notification a configurable number of times, the UE can perform a RACH based LTM cell switch to the LTM candidate cell. In some embodiments, if the acknowledgment is not received even after transmitting the notification a configurable number of times, the UE can refrain from performing an LTM cell switch to the LTM candidate cell.

In some embodiments, after (re) transmitting the notification, the UE starts a timer. If an acknowledgment of this notification is received while the timer is running, the timer is stopped. If the timer expires, the UE can retransmit the notification (if UE has not yet transmitted the notification configurable number of times). In some embodiments, if an acknowledgment is not received even after transmitting the notification a configurable number of times, the UE can perform a RACH based LTM cell switch to the LTM candidate cell. In some embodiments, if an acknowledgment is not received even after transmitting the notification a configurable number of times, the UE can refrain from performing an LTM cell switch to the LTM candidate cell.

In some embodiments, the cell switch notification is only sent if CG resources for RACH less LTM cell switch are configured for the LTM candidate cell. In some embodiments, whether to send the cell switch notification can be signaled in the LTM configuration per LTM candidate cell or commonly for all LTM candidate cells. In some embodiments, the cell switch notification is only sent if the UE has a valid TA. In some embodiments, the cell switch notification is only sent if the UE has valid TA and if CG resources for RACH less LTM cell switch are configured for the LTM candidate cell. In some embodiments, the cell switch notification is only sent if CG resources for RACH less LTM cell switch and/or CFRA resources for LTM cell switch are configured for the LTM candidate cell.

In some embodiments, when a criterion/event for switching to the LTM candidate cell is met, the UE sends/transmits the cell switch notification to the source serving cell. The cell switch notification can be a MAC CE or an RRC message or a notification transmitted on a PUCCH resource (the PUCCH resource or SR resource can be configured in the serving cell configuration for this notification). Upon receiving the notification, the serving cell sends an LTM Cell switch command MAC CE to the UE. Then the UE initiates an LTM cell switch to the LTM candidate cell indicated in the LTM Cell switch command MAC CE.

In some embodiments, until the acknowledgment for the notification is received, the UE may continue to communicate (DL and UL) with the source serving cell.

In some embodiments, the acknowledgment for the notification may include a TA of the LTM candidate cell.

In some embodiments, upon receiving the notification from the UE, the source serving cell may inform the LTM candidate cell about the cell switch and information (if any) included in the notification. In some embodiments, the LTM candidate cell can start monitoring CG resources and may provide a dynamic UL grant (via the PDCCH) to the UE after receiving this notification. In some embodiments, if the notification indicates that the UE does not have a valid TA (or does not indicate that UE has valid TA), the LTM candidate cell does not start monitoring CG resources and does not provide a dynamic UL grant (via the PDCCH) to the UE after receiving this notification. In some embodiments, the LTM candidate cell may only monitor random access resources for receiving a RACH from the UE.

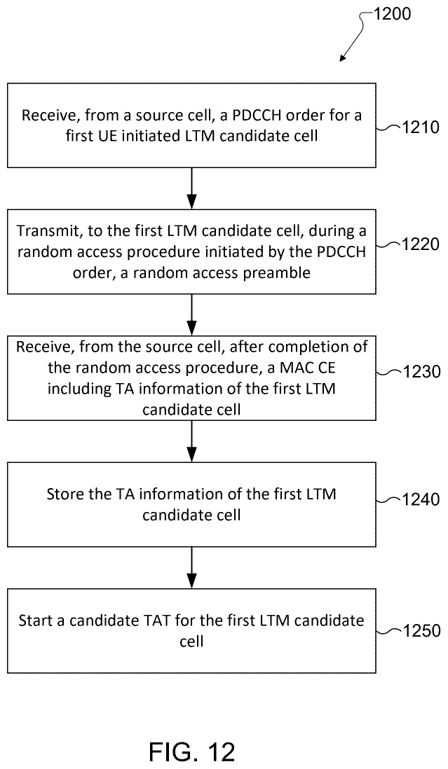

FIG. 12 illustrates another example method for UE initiated LTM 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for UE initiated lower layer triggered mobility could be used without departing from the scope of this disclosure.

In the Example of FIG. 12, method 1200 begins at step 1210. At step 1210, a UE (such as UE 116 of FIG. 1), receives, from a source cell (such as BS 102 of FIG. 1), a PDCCH order for a first UE initiated LTM candidate cell.

At step 1220, the UE transmits, to the first LTM candidate cell, during a random access procedure initiated by the PDCCH order, a random access preamble.

At step 1230, the UE receives, from the source cell, after completion of the random access procedure, a MAC CE including TA information of the first LTM candidate cell. In some embodiments, the TA information may include at least one of a TA value and an identity of the first LTM candidate cell.

At step 1240, the UE stores the TA information of the first LTM candidate cell.

Finally, at step 1250, the UE starts a candidate TAT for the first LTM candidate cell.

In some embodiments, the UE may determine whether the candidate TAT for the first LTM candidate cell has expired, and in response to a determination that the candidate TAT for the first LTM candidate cell has expired, discard the TA information of the first LTM candidate cell.

In some embodiments, the UE may receive, for one or more LTM candidate cells including the first LTM candidate cell, an LTM configuration including one or more criteria to initiate an LTM cell switch, and determine whether at least one of the criteria is met for the first LTM candidate cell. In response to the at least one criteria being met, the UE may determine whether at least one of the criteria is met for the first LTM candidate cell, and apply the stored TA information of the first LTM candidate cell for an uplink transmission to the first LTM candidate cell.

In some embodiments, the UE may determine, during the RACH less LTM cell switch, whether the candidate TAT for the first LTM candidate cell has expired. In response to a determination that the candidate TAT for the first LTM candidate cell has expired, the UE may initiate a random access procedure towards the first LTM candidate cell.

In some embodiments, the UE may determine whether at least one SSB of the first LTM candidate cell has a SS-RSRP above a threshold. In response to a determination that at least one SSB of the first LTM candidate cell has an SS-RSRP above the threshold, the UE may select a SSB of the first LTM candidate cell with a SS-RSRP above the threshold, and select a CG resource corresponding to the selected SSB. In response to a determination that at least one SSB of the first LTM candidate cell does not have an SS-RSRP above the threshold, the UE may initiate a random access procedure towards the first LTM candidate cell.

In some embodiments, the LTM configuration may include a resource configuration of the CG resource.

Although FIG. 12 illustrates one example method for UE initiated LTM 1200, various changes may be made to FIG. 12. For example, while shown as a series of steps, various steps in FIG. 12 could overlap, occur in parallel, occur in a different order, occur any number of times, be omitted, or replaced by other steps.

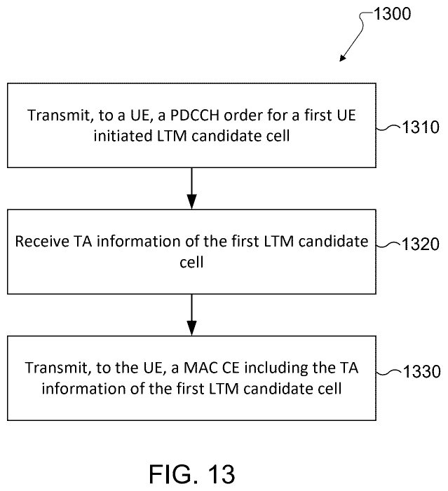

FIG. 13 illustrates another example method for UE initiated LTM 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for UE initiated lower layer triggered mobility could be used without departing from the scope of this disclosure.

In the Example of FIG. 13, method 1300 begins at step 1310. At step 1310, a BS (such as BS 102 of FIG. 1) transmits, to a UE (such as UE 116 of FIG. 1), a PDCCH order for a first UE initiated LTM candidate cell.

At step 1320, the BS receives TA information of the first LTM candidate cell. For example, in some embodiments the BS may receive the TA information from the first LTM candidate cell. In some embodiments, the BS may receive the TA information of the first LTM candidate cell in response to a random access procedure initiated by the UE for early TA acquisition for the candidate cell.

Finally, at step 1330, the BS transmits, to the UE, a MAC CE including the TA information of the first LTM candidate cell. In some embodiments, the TA information includes at least one of a TA value and an identity of the first LTM candidate cell.

In some embodiments, the BS may also transmit, to the UE, for one or more LTM candidate cells including the first LTM candidate cell, an LTM configuration including one or more criteria to initiate an LTM cell switch.

In some embodiments, the LTM configuration may include a resource configuration of a CG resource. In some embodiments, the CG resource may correspond with a synchronization signal block (SSB) of the first LTM candidate cell.

Although FIG. 13 illustrates one example method for UE initiated LTM 1300, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a source cell, a physical downlink control channel (PDCCH) order for a first UE initiated lower layer triggered mobility (LTM) candidate cell;
transmit, to the first LTM candidate cell, during a random access procedure initiated by the PDCCH order, a random access preamble; and
receive, from the source cell, after completion of the random access procedure, a medium access control (MAC) control element (CE) including timing advance (TA) information of the first LTM candidate cell; and
a processor operatively coupled to the transceiver, the processor configured to:
store the TA information of the first LTM candidate cell; and
start a candidate timing alignment timer (TAT) for the first LTM candidate cell.

2. The UE of claim 1, wherein the TA information includes at least one of a TA value and an identity of the first LTM candidate cell.

3. The UE of claim 1, wherein the processor is further configured to:
determine whether the candidate TAT for the first LTM candidate cell has expired; and
in response to a determination that the candidate TAT for the first LTM candidate cell has expired, discard the TA information of the first LTM candidate cell.

4. The UE of claim 1, wherein:
the transceiver is further configured to receive, for one or more LTM candidate cells including the first LTM candidate cell, an LTM configuration including one or more criteria to initiate an LTM cell switch; and
the processor is further configured to:
determine whether at least one of the criteria is met for the first LTM candidate cell; and
in response to the at least one of the criteria being met:
initiate a random access channel (RACH) less LTM cell switch to the first LTM candidate cell; and
apply the stored TA information of the first LTM candidate cell for an uplink transmission to the first LTM candidate cell.

5. The UE of claim 4, wherein the processor is further configured to:
determine, during the RACH less LTM cell switch, whether the candidate TAT for the first LTM candidate cell has expired; and
in response to a determination that the candidate TAT for the first LTM candidate cell has expired, initiate a random access procedure towards the first LTM candidate cell.

6. The UE of claim 4, wherein the processor is further configured to:
determine whether at least one synchronization signal block (SSB) of the first LTM candidate cell has a synchronization signal-reference signal received power (SS-RSRP) above a threshold;
in response to a determination that at least one SSB of the first LTM candidate cell has an SS-RSRP above the threshold:
select a SSB of the first LTM candidate cell with a SS-RSRP above the threshold;
select a configured grant (CG) resource corresponding to the selected SSB; and
transmit to the first LTM candidate cell in the selected CG resource during the RACH less LTM cell switch; and
in response to a determination that at least one SSB of the first LTM candidate cell does not have an SS-RSRP above the threshold, initiate a random access procedure towards the first LTM candidate cell.

7. The UE of claim 6, wherein the LTM configuration includes a resource configuration of the CG resource.

8. A base station (BS) comprising:
a processor; and
a transceiver operatively coupled to the processor, the transceiver configured to:
transmit, to a user equipment (UE), a physical downlink control channel (PDCCH) order for a first UE initiated lower layer triggered mobility (LTM) candidate cell;
receive timing advance (TA) information of the first LTM candidate cell; and
transmit, to the UE, a medium access control (MAC) control element (CE) including the TA information of the first LTM candidate cell.

9. The BS of claim 8, wherein the TA information of the first LTM candidate cell is received in response to a random access procedure initiated by the UE for early TA acquisition for the candidate cell.

10. The BS of claim 8, wherein the TA information includes at least one of a TA value and an identity of the first LTM candidate cell.

11. The BS of claim 8, wherein the transceiver is further configured to transmit, to the UE, for one or more LTM candidate cells including the first LTM candidate cell, an LTM configuration including one or more criteria to initiate an LTM cell switch.

12. The BS of claim 11, wherein the LTM configuration includes a resource configuration of a configured grant (CG) resource.

13. The BS of claim 12, wherein the CG resource corresponds with a synchronization signal block (SSB) of the first LTM candidate cell.

14. A method of operating a user equipment (UE), the method comprising:
receiving, from a source cell, a physical downlink control channel (PDCCH) order for a first UE initiated lower layer triggered mobility (LTM) candidate cell;
transmitting, to the first LTM candidate cell, during a random access procedure initiated by the PDCCH order, a random access preamble;
receiving, from the source cell, after completion of the random access procedure, a medium access control (MAC) control element (CE) including timing advance (TA) information of the first LTM candidate cell;
storing the TA information of the first LTM candidate cell; and
starting a candidate timing alignment timer (TAT) for the first LTM candidate cell.

15. The method of claim 14, wherein the TA information includes at least one of a TA value and an identity of the first LTM candidate cell.

16. The method of claim 14, further comprising:
determining whether the candidate TAT for the first LTM candidate cell has expired; and
in response to a determination that the candidate TAT for the first LTM candidate cell has expired, discarding the TA information of the first LTM candidate cell.

17. The method of claim 14, further comprising:
receiving, for one or more LTM candidate cells including the first LTM candidate cell, an LTM configuration including one or more criteria to initiate an LTM cell switch;
determining whether at least one of the criteria is met for the first LTM candidate cell; and
in response to the at least one of the criteria being met:
initiating a random access channel (RACH) less LTM cell switch to the first LTM candidate cell; and
applying the stored TA information of the first LTM candidate cell for an uplink transmission to the first LTM candidate cell.

18. The method of claim 17, further comprising:
determining, during the RACH less LTM cell switch, whether the candidate TAT for the first LTM candidate cell has expired; and
in response to a determination that the candidate TAT for the first LTM candidate cell has expired, initiating a random access procedure towards the first LTM candidate cell.

19. The method of claim 17, further comprising:
determining whether at least one synchronization signal block (SSB) of the first LTM candidate cell has a synchronization signal-reference signal received power (SS-RSRP) above a threshold;
in response to a determination that at least one SSB of the first LTM candidate cell has an SS-RSRP above the threshold:
selecting a SSB of the first LTM candidate cell with a SS-RSRP above the threshold;
selecting a configured grant (CG) resource corresponding to the selected SSB; and
transmitting to the first LTM candidate cell in the selected CG resource during the RACH less LTM cell switch; and
in response to a determination that at least one SSB of the first LTM candidate cell does not have an SS-RSRP above the threshold, initiating a random access procedure towards the first LTM candidate cell.

20. The method of claim 19, wherein the LTM configuration includes a resource configuration of the CG resource.
